(19) United States
(12) Patent Application Publication
(10) Pub. No.: US 2013/0119511 A1
(43) Pub. Date: May 16, 2013

(54) INDUCTOR HAVING BOND-WIRE AND MANUFACTURING METHOD THEREOF

(71) Applicants: Justin SHI, Ann Arbor, MI (US); Eric SOENEN, Austin, TX (US); Alan ROTH, Leander, TX (US)

(72) Inventors: Justin SHI, Ann Arbor, MI (US); Eric SOENEN, Austin, TX (US); Alan ROTH, Leander, TX (US)

(73) Assignee: TAIWAN SEMICONDUCTOR MANUFACTURING COMPANY, LTD., Hsinchu (TW)

(21) Appl. No.: 13/293,576

(22) Filed: Nov. 10, 2011

(51) Int. Cl. H01L 29/66; H01F 41/00; H01F 5/00

(52) U.S. Cl. 257/531; 336/200; 29/602.1; 257/E29.166

(57) ABSTRACT

The present application discloses an inductor including a substrate, a first conductive line and a second conductive line formed over the substrate, a passivation layer formed over the first and the second conductive lines, and a bond wire coupling an end of the first conductive line and an end of the second conductive line. At least a portion of the at least one bond wire is positioned above an upper surface of the passivation layer. The first conductive line, the bond wire, and the second conductive line are connected to form a coil.

### BACKGROUND

In an electrical circuit, an inductor may be used as a reservoir of energy in the form of magnetic fields and may have a role in power management and filtering applications. However, energy stored in the inductor may dissipate because of the inherent resistance of the inductor, the inherent hysteresis characteristic of the inductor, or the induced current at a nearby electrical component caused by the change of magnetic field of the inductor. Also, inductors usually occupy greater area, either on a printed circuit board (PCB) or in a semiconductor integrated circuit (IC), than other passive components such as resistors and capacitors.

### DESCRIPTION OF THE DRAWINGS

One or more embodiments are illustrated by way of examples, and not by limitation, in the figures of the accompanying drawings, wherein elements having the same reference numeral designations represent like elements throughout and wherein:

FIGS. 1A and 1B are a cross-sectional view and a top view of an inductor in accordance with some embodiments;

FIG. 1C is a top view of a variation of the inductor of FIG. 1A in accordance with some embodiments;

FIG. 1D is a perspective view of a portion of the inductor of FIG. 1A in accordance with some embodiments;

FIG. 2 is a flow chart of a method of manufacturing an inductor in accordance with some embodiments;

FIGS. 3A-3E are cross-sectional views of the inductor of FIG. 1A at various manufacturing stages in accordance with some embodiments;

FIGS. 4A is a cross-sectional view of an inductor in accordance with some embodiments;

FIG. 4B is a perspective view of a portion of the inductor of FIG. 4A in accordance with some embodiments;

FIG. 5 is a flow chart of a method of manufacturing an inductor in accordance with some embodiments; and

FIGS. 6A-6E are cross-sectional views of the inductor of FIG. 4A at various manufacturing stages in accordance with some embodiments.

### DETAILED DESCRIPTION

It is understood that the following disclosure provides many different embodiments, or examples, for implementing different features of the disclosure. Specific examples of components and arrangements are described below to simplify the present disclosure. These are merely examples and are not intended to be limiting. In accordance with the standard practice in the industry, various features in the drawings may not be drawn to scale and are used for illustration purposes.

The present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact. In addition, spatially relative terms, for example, “lower,” “upper,” “horizontal,” “vertical,” “above,” “below,” “up,” “down,” “top,” “bottom,” etc. as well as derivatives thereof (e.g., “horizontally,” “downwardly,” “upwardly,” etc.) are used for ease of the present disclosure of one features relationship to another feature. The spatially relative terms are intended to cover different orientations of the device including the features.

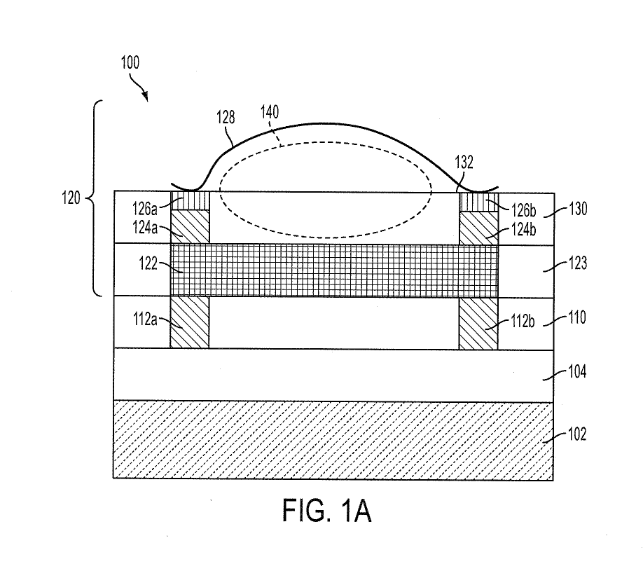

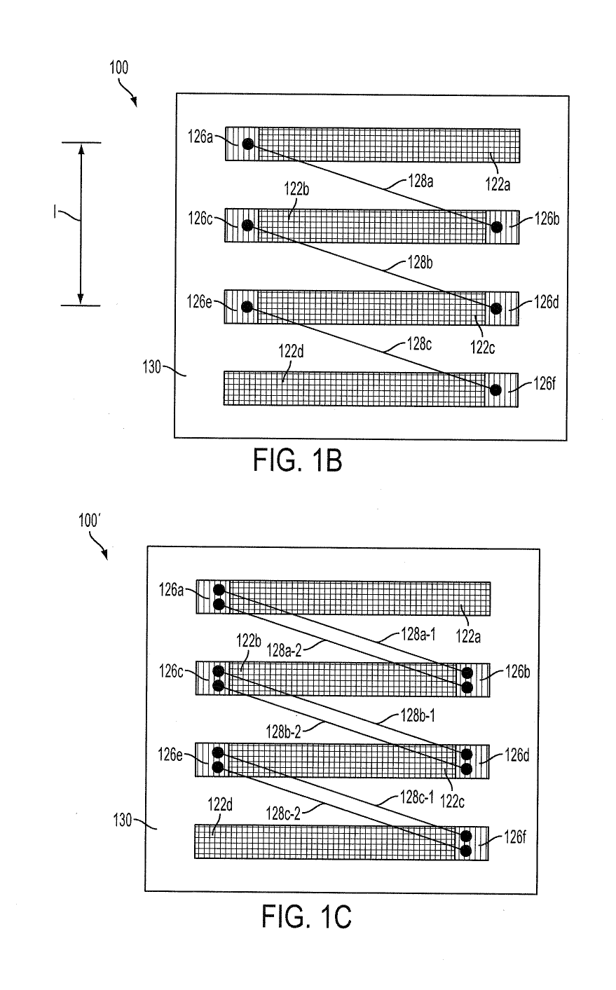

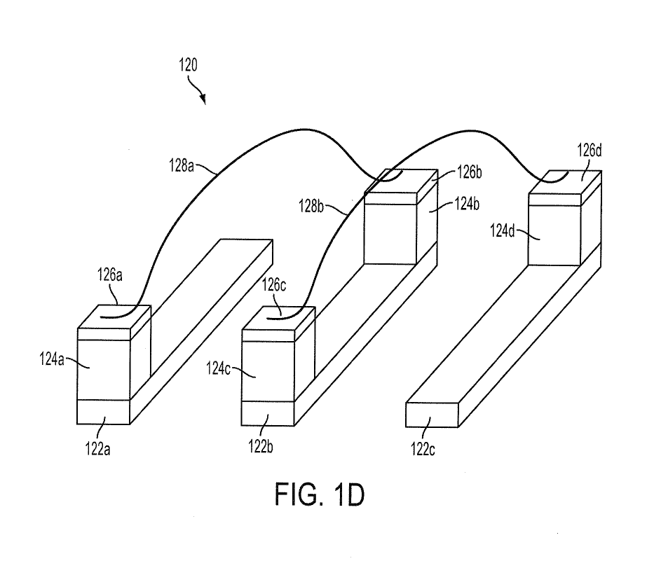

FIG. 1A is a cross-sectional view of an inductor 100 in accordance with some embodiments. The inductor 100 includes a substrate 102 and an interconnection layer 104. In at least one embodiment, the substrate 102 includes one or more active components such as transistors and/or one or more passive components such as resistors, capacitors, or inductors. In some embodiments, the interconnection layer 104 includes multiple layers of metal lines and inter-layer dielectric layers interposed between the layers of metal lines. The interconnection layer 104 connects the active and passive components in the substrate 102 to form a circuit. In at least one embodiment, there are no active or passive components in the substrate 102. In yet another embodiment, the interconnection layer 104 is omitted.

In some embodiments, the substrate 102 includes: an elementary semiconductor such as silicon or germanium in crystal, polycrystalline, or an amorphous structure; a compound semiconductor including silicon carbide, gallium arsenide, gallium phosphide, gallium nitride, indium phosphide, indium arsenide, and/or indium antimonide; an alloy semiconductor including SiGe, GaAsP, AlInAs, AlGaAs, GalnAs, GaInP, and/or GaInAsP; or combinations thereof. In at least one embodiment, the substrate 102 is an alloy semiconductor substrate having a gradient SiGe feature in which the Si and Ge composition change from one ratio at one location to another ratio at another location of the gradient SiGe feature. In another embodiment, the alloy SiGe is formed over a silicon substrate. In yet another embodiment, a SiGe substrate is strained. In some further embodiments, the semiconductor substrate 102 is a semiconductor on insulator. In some examples, the semiconductor substrate 102 includes an epitaxial layer or a buried layer. In other examples, the compound semiconductor substrate has a multilayer structure, or the substrate includes a multilayer compound semiconductor structure.

One or more conductive pads (not shown) are formed over the interconnection layer 104 or at a top-most conductive layer of the interconnection layer 104. A dielectric layer 110 is formed over the substrate 102 and the interconnection layer 104 for protecting the substrate 102 and the interconnection layer 104 from moisture or chemical pollutants. In some embodiments, the dielectric layer 110 comprises silicon nitride (SiN), silicon dioxide (SiO₂), silicon oxynitride (SiON), polyimide, or lead oxide (PBO), or combinations thereof. In some embodiments, the dielectric layer 110 is formed by Physical Vapor Deposition (PVD), Chemical Vapor Deposition (CVD), or Plasma-Enhanced CVD (PECVD). In some embodiments, a Chemical Mechanical Polishing or Planarization (CMP) process is performed after the deposition of dielectric layer 110 to planarize the surface of the dielectric layer 110.

At least two via plugs 112a/112b are formed within the dielectric layer 110 and connect corresponding conductive pads with the coil portion 120 of the inductor 100. In at least one embodiment, the via plugs 112a/112b are formed by first forming openings in the dielectric layer 110 through photolithography processes and then filling the openings with conductive materials by PVD, CVD, sputtering, evaporation, Damascene, or Dual-Damascene processes. In some embodiments, the coil portion 120 is connected to external electrical devices through other signal paths, such as conductive pads formed on an upper surface of the inductor 100, and thus the dielectric layer 110, the via plugs 112a/112b, and/or the conductive pads are omitted.

A plurality of conductive lines 122 are formed over the dielectric layer 110. In some embodiments, conductive lines 122 are formed by first forming a dielectric layer 123, forming an opening in the dielectric layer 123 through photolithography processes, and then filling the opening with conductive materials by PVD, CVD, sputtering, evaporation, Damascene, or Dual-Damascene processes. In some embodiments, a CMP process is performed after the deposition of conductive lines 122 to planarize the surface of the conductive lines 122. In some embodiments, the conductive lines are metal lines comprising copper, aluminum, or copper-aluminum alloy. In some embodiments, the dielectric layer 123 comprises the same or different materials as the dielectric layer 110 or passivation layer 130.

Passivation layer 130 is formed over the conductive lines 122 for protecting the substrate 102 and the interconnection layer 104 from moisture or chemical pollutants. A plurality of conductive members such as via plugs 124a/124b and/or pads 126a/126b are formed in the passivation layer 130 and connect corresponding ends of the plurality of conductive lines 122. In at least one embodiment, the passivation layer 130, via plugs 124a/124b, and pads 126a/126b are formed by the same or similar methods for forming the dielectric layer 110 and the via plugs 112a/112b.

For each pair of the conductive lines 122, at least one bond wire 128 is formed to connect the pads 126a/126b located at opposite distal ends of the pair of conductive lines 122 and thus coupling the pair of conductive lines 122. At least a portion of the bond wire 122 is positioned above an upper surface 132 of the passivation layer 130. The conductive lines 122, the via plugs 124a/124b, the pads 126a/126b, and the at least one bond wire 128 together are connected to form the coil portion 120 of the inductor 100, and the coil 120 further defines a core portion 140 of the coil 120. In some embodiments, a barrier layer is formed on an upper surface of the via plugs 124a/124b in the metal interface with pads 126a/126b to prevent contamination and spreading. The barrier layer may comprise Ti or Ta. In some embodiments, the pads 126a/126b are omitted, and the at least one bond wire 128 is in contact with the respective via plugs 124a/124b directly. In yet some other embodiments, the pads 126a/126b and the via plugs 124a/124b are omitted, and the one or more bond wires 128 are in direct contact with the respective ends of the conductive lines 122.

FIG. 1B is a top view of the inductor 100 depicted in FIG. 1A in accordance with some embodiments. The conductive lines 122 (FIG. 1A) include four conductive lines 122a-122d. In some embodiments, the inductor 100 has greater or fewer than four conductive lines 122/122a-122d. A first pad 126a is coupled to an end of a first conductive line 122a through a first via plug 124a or 124b (FIG. 1A), a second pad 126b is coupled to an end of a second conductive line 122b through a second via plug 124a or 124b, and a bond wire 128a is formed to connect the first pad 126a and the second pad 126b. The first conductive line 122a, the first via plug 124a or 124b, the first pad 126a, the bond wire 128a, the second pad 126b, the second via plug 124a or 124b, and the second conductive line 122b together at least partially form the coil portion 120 and define one turn for the coil portion 120.

Similarly, a third pad 126c is coupled to another end of the second conductive line 122b through a third via plug, a fourth pad 126d is coupled to an end of the third conductive line 122c through a fourth via plug, and a bond wire 128b is formed to connect the third pad 126c and the fourth pad 126d. The second conductive line 122b, the third via plug, the third pad 126c, the bond wire 128b, the fourth pad 126d, the fourth via plug, and the third conductive line 122c together define another turn for the coil portion 120. In some embodiments, the same or similar basic structure (or turns) of the coil portion is repeated to form the coil portion 120, which then has more than two turns. For example, in the embodiment depicted in FIG. 1B, the coil 120 has three turns. In at least one embodiment, the coil portion 120 has one turn.

In some embodiments, the bond wire 128 or 128a-128c comprises copper, gold, or copper-gold alloy. The conductive lines 122 or 122a-122d are metal lines each having a width ranges from 10 μm to 1000 μm and a height ranges from 0.1 μm to 30 μm. The conductive lines 122 or 122a-122d are arranged in parallel and a spacing between adjacent conductive lines ranges from 0.07 μm to 100 μm. In some embodiments, conductive lines 122 or 122a-122d have the same or different dimensions. In some embodiments, the conductive lines 122 or 122a-122d are not arranged in parallel.

The number of turns and the dimension of the inductor 100 are set based on a predetermined inductance value. The resulting inductance of the inductor 100 is calculated based upon the proximate equation:

$$L = \frac{{μ}_{0} {μ}_{r} {N}^{2} A}{l}$$

where μ₀ is the permeability of free space, μᵣ is the relative permeability of the material at the core portion 140 of the coil portion 120, N is the number of turns, A is the cross-sectional area of the coil portion 120, and I is the length of the coil portion 120. In the example of FIG. 1A, because the core portion 140 is occupied mostly by air and the passivation layer 130, the relative permeability of the core portion 140 is equal to or slightly greater than 1.0.

FIG. 1C is a top view of a variation 100′ of the inductor 100 depicted in FIG. 1A in accordance with some embodiments. Two bond wires 128a-1/128a-2, 128b-1/128b-2, or 128c-1/128c-2 are used for connecting corresponding pair of pads 126a-126f and thus coupling the corresponding ends of conductive lines 122. Using multiple bonding wires reduces the resistance between the conductive lines 122. In at least some other embodiments, more than two bond wires are formed to couple corresponding pairs of conductive lines 122.

FIG. 1D is a perspective view of a portion of the inductor 100 of FIG. 1A in accordance with some embodiments. The conductive lines 122a/122b/122c, the plugs 124a/124b/124c/124d, the pads 126a/126b/126c/126d, and the at least one bond wire 128a/128b are connected to form a coil portion 120 having two turns. In some embodiments, the same or similar basic structure (or turns) is repeated to form the coil portion 120 having more than two turns.

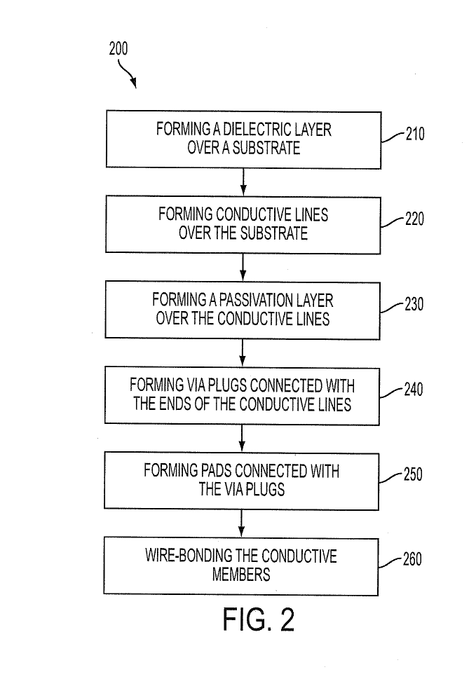

FIG. 2 is a flow chart of a method 200 of manufacturing an inductor 100 in accordance with some embodiments. It is understood that additional processes may be provided before, during, and/or after the method 200 depicted in FIG. 2, and that some other processes may only be briefly described herein.

In operation 210, a dielectric layer 110 such as an interlayer dielectric layer or a passivation layer is formed over a substrate 102. In some embodiments, the dielectric layer 110 comprises silicon nitride (SiN), silicon dioxide (SiO₂), silicon oxynitride (SiON), polyimide, or lead oxide (PBO), or combinations thereof. In some embodiments, the dielectric layer 110 is formed by Physical Vapor Deposition (PVD), Chemical Vapor Deposition (CVD), or Plasma-Enhanced CVD (PECVD). At least two via plugs 112a/112b are formed within the dielectric layer 110 and are connected to corresponding conductive pads formed on the substrate 102.

In operation 220, a plurality of metal lines 122 is formed over the dielectric layer 110 and the substrate 102. In some embodiments, there are two or more metal lines formed over the dielectric layer 110. In some embodiments, conductive lines 122 are formed by first forming a dielectric layer 123, forming an opening in the dielectric layer 123 through photolithography processes, and then filling the opening with conductive materials by PVD, CVD, sputtering, evaporation, Damascene, or Dual-Damascene processes. In some embodiments, the metal lines comprise copper, aluminum, or copper-aluminum alloy.

In operation 230, a passivation layer 130 is formed over the plurality of metal lines. In at least one embodiment, the passivation layer 130 comprises silicon nitride (SiN), silicon dioxide (SiO₂), silicon oxynitride (SiON), polyimide, or lead oxide (PBO), or combinations thereof. In some embodiments, the passivation layer 130 is formed by Physical Vapor Deposition (PVD), Chemical Vapor Deposition (CVD), or Plasma-Enhanced CVD (PECVD).

In operation 240, at least two via plugs 124a/124b are formed within the passivation layer 130 and are connected to corresponding distal ends of the plurality of metal lines 122. For example, if there are two metal lines, i.e., a first metal line and a second metal line, formed over the dielectric layer, at least two via plugs are also formed including a first via plug connected to an end of the first metal line and a second via plug connected to an end of the second metal line.

In operation 250, a plurality of conductive pads 126a/126b is formed to connect with corresponding via plugs 124a/124b formed in the passivation layer 130. For example, if there are two metal lines formed over the dielectric layer 110, at least two conductive pads are formed including a first pad connected with the first via plug and a second pad connected with the second via plug. In some embodiments, the via plugs 124a/124b and the conductive pads 126a/126b are connectively referred to as conductive members.

Then, in operation 260, a wire-bonding process is performed to connect the conductive pads by one or more bond wires 128. The first metal line, the first via plug, the first pad, the bond wire, the second pad, the second via plug, and the second metal line are connected to have a spiral shape and form a one-turn coil. In some embodiments, for every paired conductive pads located at distal ends of adjacent metal lines, one or more bond wires are used to create electrical connection between the paired conductive pads to minimize the resistance between the paired conductive pads. In some embodiments, operation 250 is omitted, and the one or more bond wires 128 are in contact with the respective via plugs 124a/124b directly. In some embodiments, operations 240/250 are omitted, and the one or more bond wires 128 are in direct contact with the respective ends of the conductive lines 122.

In some embodiments, if a third metal line is formed during operation 220 over the dielectric layer 110, a third via plug and a fourth via plug respectively connected to another end of the second metal line and to an end of the third metal line are also formed accordingly during the operation 240. A third pad connected with the third via plug and a fourth pad connected with the fourth via plug are formed during the operation 250, and the third pad and the fourth pad are connected during operation 260 by another bond wire.

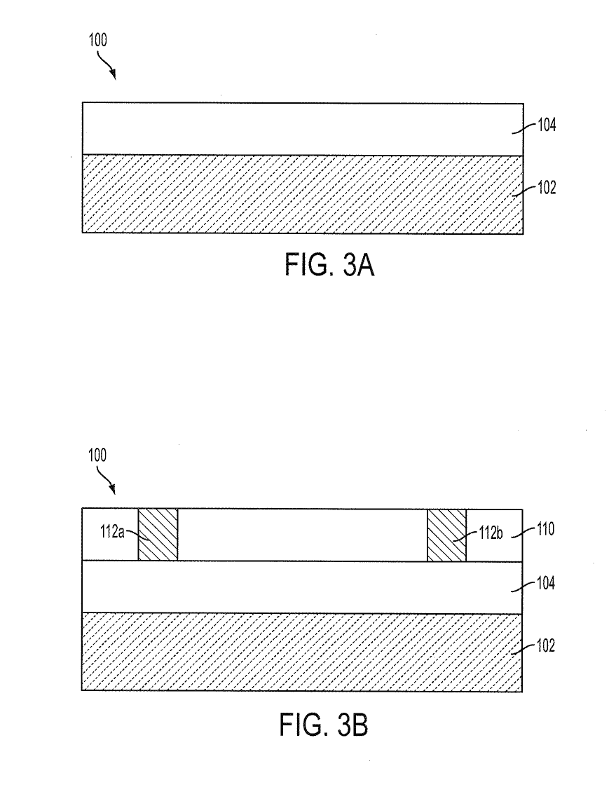

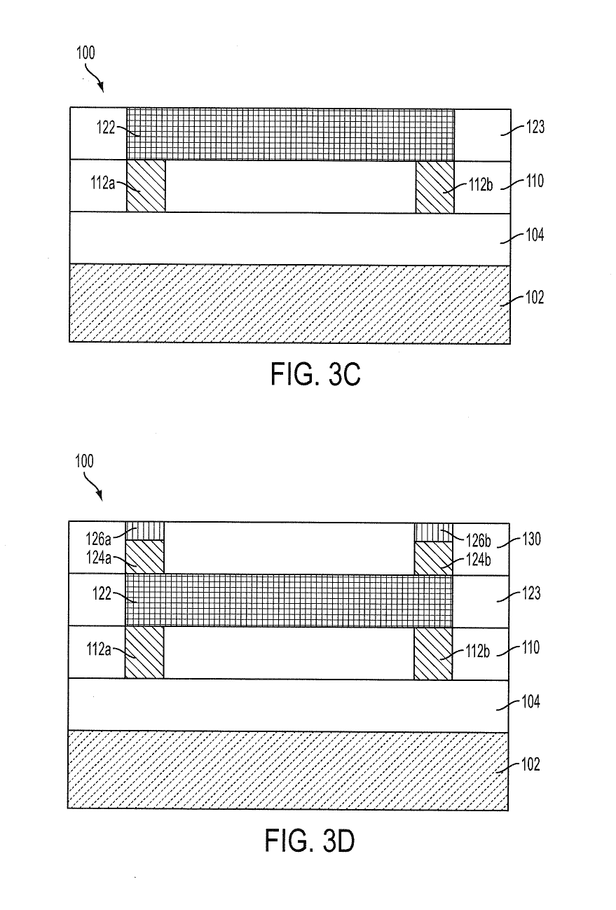

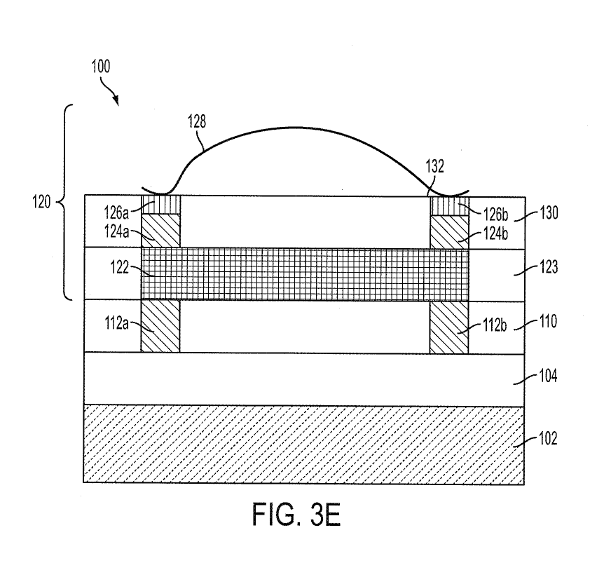

FIGS. 3A-3E are cross-sectional views of the inductor of FIG. 1A at various manufacture stages in accordance with some embodiments. As depicted in FIG. 3A, inductor 100 includes a substrate 102 and an interconnection layer 104. In at least one embodiment, the interconnection layer 104 is omitted.

As depicted in FIG. 3B, a dielectric layer 110 such as an interlayer dielectric layer or a passivation layer is formed over the substrate 102 and the interconnection layer 104 (corresponding to operation 210 of FIG. 2). In some embodiments, the dielectric layer 110 comprises silicon nitride (SiN), silicon dioxide (SiO₂), silicon oxynitride (SiON), polyimide, or lead oxide (PBO), or combinations thereof. In some embodiments, the dielectric layer 110 is formed by Physical Vapor Deposition (PVD), Chemical Vapor Deposition (CVD), or Plasma-Enhanced CVD (PECVD). At least two via plugs 112a/112b are formed within the dielectric layer 110 and connects with corresponding conductive pads (not shown) of the interconnection layer 104.

As depicted in FIG. 3C, then a plurality of conductive lines 122 are formed over the dielectric layer 110 (corresponding to operation 220 of FIG. 2). In some embodiments, conductive lines 122 are formed by first forming a dielectric layer 123, forming an opening in the dielectric layer 123 through photolithography processes, and then filling the opening with conductive materials by PVD, CVD, sputtering, evaporation, Damascene, or Dual-Damascene processes.

As depicted in FIG. 3D, then a passivation layer 130 is formed over the conductive lines 122 (corresponding to operation 230 of FIG. 2). In some embodiments, the passivation layer 130 comprises silicon nitride (SiN), silicon dioxide (SiO₂), silicon oxynitride (SiON), polyimide, or lead oxide (PBO), or combinations thereof. In some embodiments, the passivation layer 130 is formed by Physical Vapor Deposition (PVD), Chemical Vapor Deposition (CVD), or Plasma-Enhanced CVD (PECVD). A plurality of via plugs 124a/124b is formed in the second passivation layer 130 and connects corresponding ends of the plurality of conductive lines 122 (corresponding to operation 240 of FIG. 2). A plurality of pads 126a/126b is connected with the via plugs 124a/124b, respectively (corresponding to operation 250 of FIG. 2).

As depicted in FIG. 3E, for each pair of the conductive lines 122, at least one bond wire 128 is formed to connect the pads 126a/126b located at opposite distal ends of the paired conductive lines 122 (corresponding to operation 260 of FIG. 2). At least a portion of the bond wire 122 is positioned above an upper surface 132 of the passivation layer 130. The conductive lines 122, the via plugs 124a/124b, the pads 126a/126b, and the at least one bond wire 128 together are connected to form a coil portion 120 of the inductor 100.

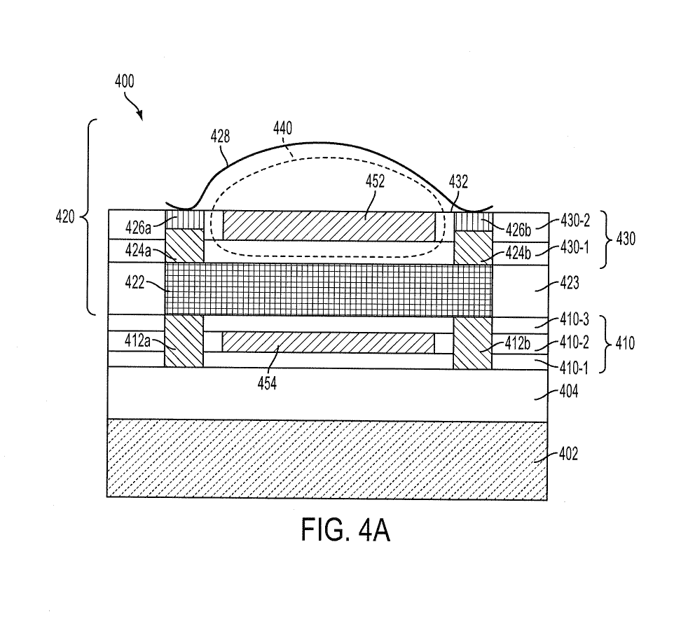

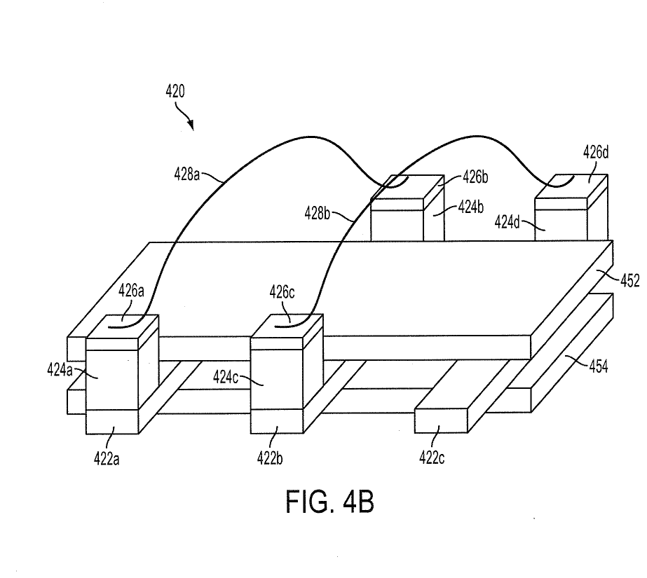

FIG. 4A is a cross-sectional view of an inductor 400 in accordance with some embodiments. The inductor 400 includes a substrate 402 and an interconnection layer 404, and one or more conductive pads (not shown) are formed over the interconnection layer 404 or at a top-most conductive layer of the interconnection layer 404. The inductor 400 includes a dielectric layer 410 formed over the substrate 402, at least two via plugs 412a/412b formed within the dielectric layer 410 and connected with corresponding conductive pads of the interconnection layer 404, a plurality of conductive lines 422 is formed over the dielectric layer 410, and passivation layer 430 is formed over the conductive lines 422. A plurality of via plugs 424a/424b is formed in the second passivation layer 430 and connects corresponding ends of the plurality of conductive lines 422. A plurality of pads 426a/426b is connected with the via plugs 424a/424b, respectively. For each pair of the conductive lines 422, at least one bond wire 428 is formed to connect the pads 426a/426b located at opposite distal ends of the pair of the conductive lines 422. At least a portion of the bond wire 422 is positioned above an upper surface 432 of the passivation layer 430.

The conductive lines 422, the via plugs 424a/424b, the pads 426a/426b, and the at least one bond wire 428 together are connected to form the coil portion 420 of the inductor 400, and the coil 420 further defines a core portion 440 of the coil 420. In some embodiments, a barrier layer is formed on an upper surface of the via plugs 424a/424b in the metal interface with pads 426a/426b. The barrier layer may comprise Ti or Ta. In some embodiments, the pads 426a/426b are omitted, and the at least one bond wire 428 is in contact with the respective via plugs 424a/424b directly. In some embodiments, the pads 426a/426b and the via plugs 424a/424b are omitted, and the at least one bond wire 428 is in direct contact with the respective ends of the conductive lines 422.

First ferromagnetic member 452 is formed over the plurality of conductive lines 422, under the bond wire 440, and between the first pad and the second pad 426a/426b. In other words, the first ferromagnetic member 452 is positioned in the core portion 440 of the coil 420 and surrounded by at least the plurality of conductive lines 422 and the bond wire 440. The first ferromagnetic member 452 has a relative permeability higher than that of the free space or air, and thus the equivalent relative permeability of the core portion 440 of the coil 420 is higher than 1.0. In some embodiments, the first ferromagnetic member comprises iron, ferrite, cobalt, nickel, or a combination thereof, and the equivalent permeability of the core portion 440 ranges from 2×10⁻⁵ H/m to 1×10⁻³ H/m.

First ferromagnetic member 452 is positioned to avoid direct contact with via plugs 424a/424b, the pads 426a/426b, and the conductive lines 422 to avoid shorting the conductive lines 422. In at least one embodiment, the passivation layer 430 has two sub-layers 430-1/430-2, and the first ferromagnetic member 452 is formed by first forming a first sub-layer 430-1 of the passivation layer 430 over the conductive lines 422, and then depositing ferromagnetic material before forming the second sub-layer 430-2 of the passivation layer 430. The deposition of the ferromagnetic member 452 is performed by CVD, PVD, electro-plating, sputtering, Pulse Laser Deposition (PLD), or spin-coating. In some embodiments, first ferromagnetic member 452 is formed by first forming an opening in the passivation layer 430 through photolithography processes, and then filling the opening with ferromagnetic materials by PVD or CVD processes.

Further, a second ferromagnetic member 454 is formed over the substrate and under the plurality of conductive lines 422. The second ferromagnetic member 452 has a relative permeability higher than that of the free space or air, and thus a portion of the magnetic flux, caused by a current passing through the coil 420, under the plurality of conductive lines 422 is guided through the second ferromagnetic member 452, and thus the magnetic field intensity at the substrate 402 and the interconnection layer 404 underneath the coil 420 is reduced or “shielded” by the second ferromagnetic member 452. In some embodiments, the second ferromagnetic member comprises iron, ferrite, cobalt, nickel, or a combination thereof.

Second ferromagnetic member 454 is positioned to avoid direct contact with the conductive lines 422 and the via plugs 412a and 412b to avoid shorting the conductive lines 422. In at least one embodiment, the passivation layer 410 has three sub-layers 410-1/410-2/410-3, and the second ferromagnetic member 454 is formed by first forming a first sub-layer 410-1 over the interconnection layer 404, and then depositing ferromagnetic material over the first sub-layer 410-1 before forming the second and third sub-layers 410-2/410-3. The deposition of the ferromagnetic member 454 is performed by CVD, PVD, electro-plating, sputtering, Pulse Laser Deposition (PLD), or spin-coating. In some embodiments, second ferromagnetic member 454 is formed by forming an opening in the in the dielectric layer 410 through photolithography processes, and then filling the opening with ferromagnetic materials by PVD or CVD processes.

FIG. 4B is a perspective view of a portion of the inductor 400 of FIG. 4A in accordance with some embodiments. The conductive lines 422a/422b/422c (i.e., 422 in FIG. 4A), the plugs 424a/424b/424c/424d, the pads 426a/426b/426c/426d, and the at least one bond wire 428a/428b are connected to form a coil 420 having two turns. In some embodiments, the same or similar basic structure is repeated to form the coil 420 having more than two turns. A first ferromagnetic member 452 is formed in the core portion 440 (FIG. 4A) of the coil 420 to increase the inductance value of the inductor 400, and a second ferromagnetic member 454 is formed under the coil 420 to shield the structure underneath the inductor 400 from the magnetic field generated by the coil 420 of the inductor 400.

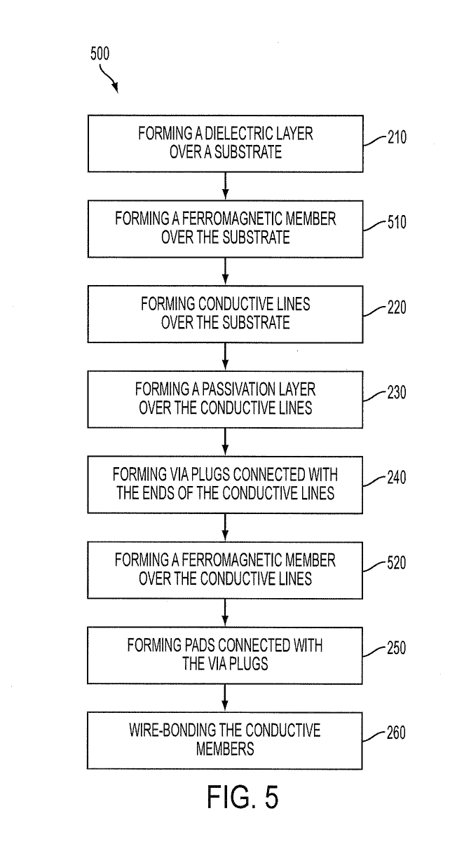

FIG. 5 is a flow chart of a method 500 of manufacturing an inductor 400 in accordance with some embodiments. It is understood that additional processes may be provided before, during, and/or after the method 500 depicted in FIG. 5, and that some other processes may only be briefly described herein. Also, operations that are the same or similar to the operations depicted in FIG. 2 are given the same reference numerals, and their corresponding descriptions are not repeated.

In operation 510, during or after the formation of a dielectric layer 410, a ferromagnetic member 454 is formed over the substrate 402. In some embodiments, the ferromagnetic member comprises iron, ferrite, cobalt, nickel, or a combination thereof. In some embodiments, the ferromagnetic member is formed by first forming an opening in the dielectric layer, and then filling the opening with ferromagnetic materials by PVD or CVD processes. In some embodiments, operation 510 is performed before or during operation 210. The deposition of the ferromagnetic member 454 is performed by CVD, PVD, electro-plating, sputtering, Pulse Laser Deposition (PLD), or spin-coating.

Then the operations 220-240 are performed as described above with regard to FIG. 2. After the formation of the ferromagnetic member 454 and the dielectric layer 410, a plurality of conductive lines 422 is formed over the ferromagnetic member (operation 220). After forming the via plugs in operation 240, in operation 520, ferromagnetic member 452 is formed over the plurality of conductive lines 422. In some embodiments, the ferromagnetic member 452 comprises iron, ferrite, cobalt, nickel, or a combination thereof. In some embodiments, the ferromagnetic member 452 is formed by first forming an opening in the passivation layer 430, and then filling the opening with ferromagnetic materials by PVD or CVD processes. In at least one embodiment, the ferromagnetic member 452 is formed by first forming an first sub-layer 430-1 over the conductive lines 422, and then depositing ferromagnetic material over the first sub-layer 430-1 before forming the second sub layer 430-2 of the passivation layer 430. The deposition of the ferromagnetic member is performed by CVD, PVD, electro-plating, sputtering, Pulse Laser Deposition (PLD), or spin-coating.

Thereafter, in operations 250 and 260, the conductive pads 426 and bond wire(s) 428 are formed. In some embodiments, operation 520 is performed after the formation of the conductive pads (operation 250) or before the formation of the via plugs (operation 240). In some embodiments, at least one of the operations 510 and 520 is omitted. In some embodiments, the formation of the conductive pads and/or the via plugs is omitted.

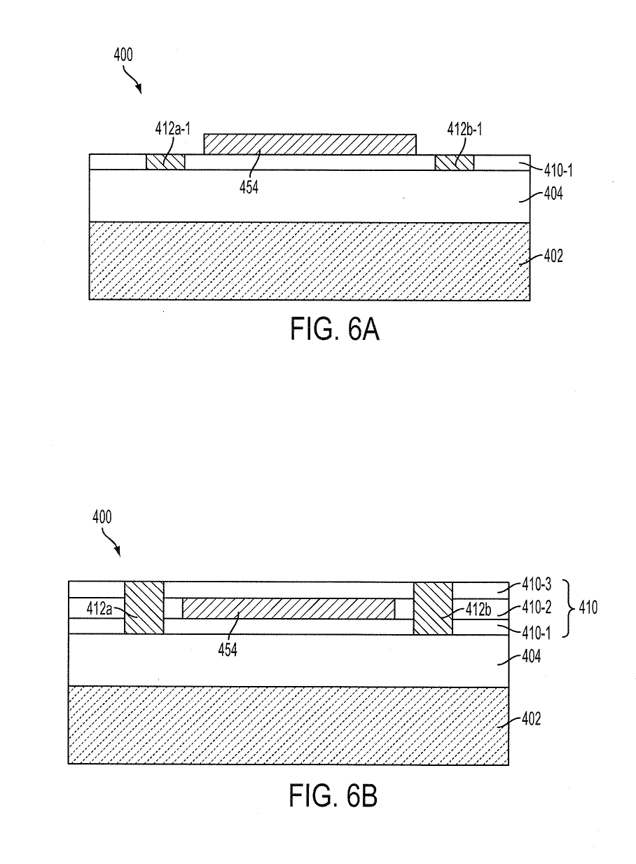

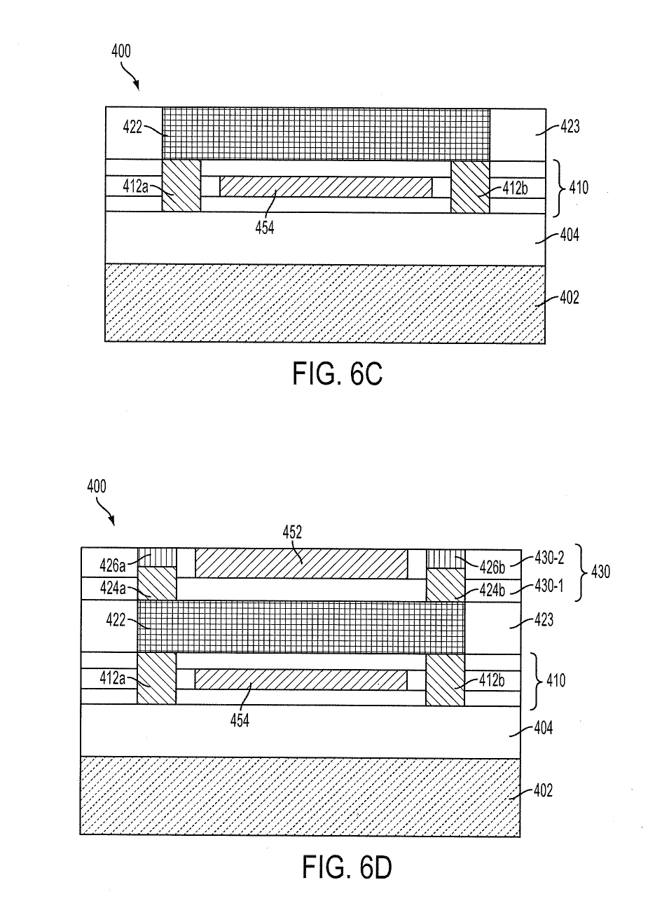

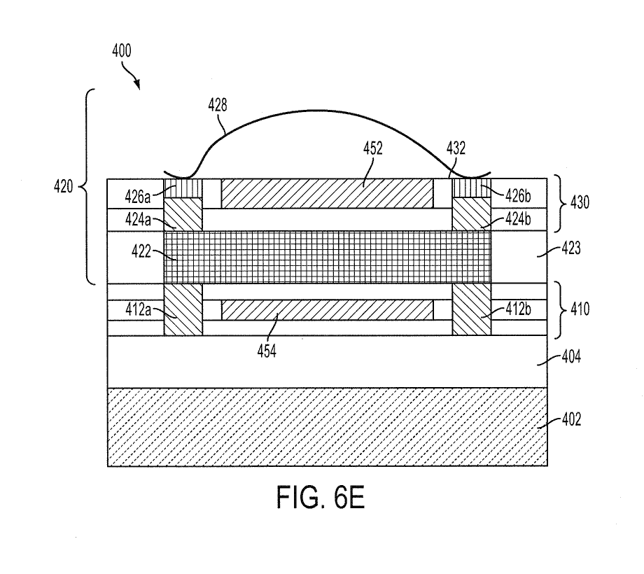

FIGS. 6A-6E are cross-sectional views of the inductor of FIG. 6A at various manufacture stages in accordance with some embodiments. As depicted in FIG. 6A, inductor 400 includes a substrate 402 and an interconnection layer 404. One or more conductive pads (not shown) are formed over the interconnection layer 404 or at a top-most conductive layer of the interconnection layer 404. In at least one embodiment, the interconnection layer 404 is omitted. A first sub-layer 410-1 of the dielectric layer 410 is formed over the substrate 402 and the interconnection layer 404 (corresponding to operation 210 of FIG. 5), and optionally the second and/or the third sub-layers 410-2/410-3 are formed during or after the formation of ferromagnetic member 454. In some embodiments, the dielectric layer 410 comprises silicon nitride (SiN), silicon dioxide (SiO₂), silicon oxynitride (SiON), polyimide, or lead oxide (PBO), or combinations thereof. In some embodiments, the dielectric layer 410 is formed by Physical Vapor Deposition (PVD), Chemical Vapor Deposition (CVD), or Plasma-Enhanced CVD (PECVD). At least two via plugs 412a-1/412b-1 are formed within the dielectric layer 410 (where is 414?) and connects with corresponding conductive pads of the interconnection layer 404.

A ferromagnetic member 454 is formed over the substrate 402, the interconnection layer 404, and the substrate 402 (corresponding to operation 510 of FIG. 5). In some embodiments, the ferromagnetic member 454 comprises iron, ferrite, cobalt, nickel, or a combination thereof. In at least one embodiment, the ferromagnetic member 454 is formed by depositing ferromagnetic material over interconnection layer 404 after or in conjunction with the formation of the dielectric layer 410. In some embodiments, the deposition of the ferromagnetic member 454 is performed by CVD, PVD, electro-plating, sputtering, Pulse Laser Deposition (PLD), or spin-coating.

As depicted in FIG. 6B, the second and third sub-layers 410-2/410-3 of the dielectric layer 410 are formed to surround and cover the ferromagnetic member 454. The sub-layers 410-1, 410-2, and 410-3 are collectively referred to as the dielectric layer 410. The via plugs 412a/412b are formed to extend via plugs 412a-1/412b-1 through the entire thickness of the dielectric layer 410. In some embodiments, the ferromagnetic member 454 is formed by first forming the dielectric layer 410 and an opening in the dielectric layer 410, and then filling the opening with ferromagnetic materials by PVD or CVD processes. In some embodiments, via plugs 412a and 412b are entirely formed after the formation of ferromagnetic member 454.

Then, as depicted in FIG. 6C, a plurality of conductive lines 422 is formed over the dielectric layer 410 and the ferromagnetic member 454 (corresponding to operation 230 of FIG. 5). In some embodiments, conductive lines 422 are formed by first forming a dielectric layer 423, forming an opening in the dielectric layer 423, and then filling the opening with conductive materials by PVD, CVD, sputtering, evaporation, Damascene, or Dual-Damascene processes. .

As depicted in FIG. 6D, then a second passivation layer 430 is formed over the conductive lines 422 (corresponding to operation 230 of FIG. 5). A plurality of via plugs 424a/424b is formed in the second passivation layer 430 and connects corresponding ends of the plurality of conductive lines 422 (corresponding to operation 240 of FIG. 5). Another ferromagnetic member 452 is formed over the plurality of metal lines (corresponding to operation 520 of FIG. 5). In some embodiments, the ferromagnetic member 452 comprises iron, ferrite, cobalt, nickel, or a combination thereof.

In at least one embodiment, the ferromagnetic member 452 is formed by first forming a first sub-layer 430-1 over the conductive lines 422, and then depositing ferromagnetic material over the first sub-layer 430-1 before forming the second-sub-layer 430-2 of the passivation layer 430. The deposition of the ferromagnetic member 452 is performed by CVD, PVD, electro-plating, sputtering, Pulse Laser Deposition (PLD), or spin-coating. Also, a plurality of pads 426a/426b is connected with the via plugs 424a/424b, respectively (corresponding to operation 250 of FIG. 5). In some embodiments, the ferromagnetic member 452 is formed by first forming an opening in the passivation layer 430, and then filling the opening with ferromagnetic materials by PVD or CVD processes. In some embodiments, vias 424a/424b and pads 426a/426b are formed after the formation of ferromagnetic member 452.

As depicted in FIG. 6E, for each pair of adjacent conductive lines 422, at least one bond wire 428 is formed to connect the pads 426a/426b located at opposite distal ends of the paired conductive lines 422 (corresponding to operation 260 of FIG. 5). At least a portion of the bond wire 422 is positioned above an upper surface 432 of the passivation layer 430. The conductive lines 422, the via plugs 424a/424b, the pads 426a/426b, and the at least one bond wire 428 together are connected to form a coil portion 420 of the inductor 400. In some embodiments, the pads 426a/426b are omitted, and the at least one bond wire 428 is in contact with the respective via plugs 424a/424b directly. In some embodiments, the via plugs 424a/424b are omitted, and the at least one bond wire 428 is in direct contact with the respective ends of the conductive lines 422.

In some embodiments, an inductor includes a substrate, a first conductive line and a second conductive line formed over the substrate, a passivation layer formed over the first and the second conductive lines, and a bond wire coupling an end of the first conductive line and an end of the second conductive line. The first conductive line, the bond wire, and the second conductive line are connected to form a coil.

In some embodiments, a method of manufacturing an inductor includes forming a first metal line and a second metal line over a substrate and forming a passivation layer over the first and the second metal lines. The method further includes forming a turn of a coil including the first metal line and the second metal line by coupling an end of the first metal line and an end of the second metal line with a bond wire.

In some embodiments, a semiconductor structure includes a substrate, a plurality of conductive lines formed over the substrate, a passivation layer formed over the plurality of conductive lines, a plurality of conductive members formed in the passivation layer and configured to connect corresponding ends of the plurality of conductive lines, and, for each pair of conductive lines, at least one bond wire connecting two conductive members located at opposite distal ends of the pair of the plurality of conductive lines. The conductive lines, the conductive members, and the at least one bond wire are connected to form a coil.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An inductor comprising:
a substrate;
a first conductive line and a second conductive line formed over the substrate;
a passivation layer formed over the first and the second conductive lines;
a bond wire coupled between an end of the first conductive line and an end of the second conductive line, at least a portion of the bond wire positioned above an upper surface of the passivation layer,
the first conductive line, the bond wire, and the second conductive line being connected to form a coil.

2. The inductor of claim 1, wherein the first conductive line, the bond wire, and the second conductive line defines a first turn of the coil, and the inductor further comprises:
a third conductive line formed between the substrate and the passivation layer and in parallel with the first and the second conductive lines; and
another bond wire coupled between another end of the second conductive line and an end of the third conductive line,
the second conductive line, the another bond wire, and the third conductive line being connected to form a second turn of the coil.

3. The inductor of claim 1, further comprising:
a first ferromagnetic member surrounded at least by the first and the second conductive lines and the bond wire.

4. The inductor of claim 3, wherein the first ferromagnetic member comprises iron, ferrite, cobalt, nickel, or a combination thereof.

5. The inductor of claim 3, further comprising:
a second ferromagnetic member formed over the substrate and under the first and the second conductive lines.

6. The inductor of claim 1, further comprising:
a ferromagnetic member formed over the substrate and under the first and the second conductive lines.

7. The inductor of claim 1, further comprising:
another bond wire coupled between the end of the first conductive line and the end of the second conductive line.

8. The inductor of claim 1, wherein the first conductive line and the second conductive line comprise copper, aluminum, or copper-aluminum alloy.

9. The inductor of claim 1, wherein the bond wire comprises copper, gold, or copper-gold alloy.

10. A method of manufacturing an inductor, comprising:
forming a first metal line and a second metal line over a substrate;
forming a passivation layer over the first and the second metal lines; and
forming a turn of a coil including the first metal line and the second metal line by coupling, after the formation of the passivation layer, an end of the first metal line and an end of the second metal line with a bond wire.

11. The method of claim 10, further comprising:
forming a third metal line over the substrate; and
forming another turn of the coil including the second metal line and third second metal line by coupling the another end of the second metal line and an end of the third metal line with another bond wire.

12. The method of claim 10, further comprising:
forming a first ferromagnetic member over the first and the second metal lines before the formation of the bond wire.

13. The method of claim 12, further comprising:
forming a second ferromagnetic member over the substrate before the formation of the first and the second metal lines.

14. The method of claim 10, further comprising:
forming a ferromagnetic member over the substrate before the formation of the first and the second metal lines.

15. The method of claim 10, further comprising:
coupling the end of the first metal line and the end of the second metal line with another bond wire.

16. A semiconductor structure comprising:
a substrate;
a plurality of conductive lines formed over the substrate;
a passivation layer formed over the plurality of conductive lines;
a plurality of conductive members formed in the passivation layer and configured to connect corresponding ends of the plurality of conductive lines; and
for each pair of conductive lines, at least one bond wire connecting two conductive members located at opposite distal ends of the pair of the plurality of conductive lines,
the conductive lines, the conductive members, and the at least one bond wire being connected to form a coil.

17. The semiconductor structure of claim 16, wherein the coil defines a core portion, and the semiconductor structure further comprising:
a first ferromagnetic member formed to occupy at least a portion of the core portion.

18. The semiconductor structure of claim 17, wherein the first ferromagnetic member comprises iron, ferrite, cobalt, nickel, or a combination thereof.

19. The semiconductor structure of claim 17, further comprising:
a second ferromagnetic member formed between the substrate and the conductive lines.

20. The semiconductor structure of claim 17, wherein the coil has one or more turns.
